(19) United States
(12) Patent Application Publication
(10) Pub. No.: US 2026/0028176 A1
(43) Pub. Date: Jan. 29, 2026

(54) FREIGHT CONTAINER WITH COOLING DEVICE

(71) Applicant: IPETRONIK GmbH & Co. KG, Baden-Baden (DE)

(72) Inventors: Frank PASCH, Baden-Baden (DE); Bernd ZEITVOGEL, Rastatt (DE); Claus ANDERER, Gaggenau (DE)

(21) Appl. No.: 19/236,691

(22) Filed: Jun. 12, 2025

(30) Foreign Application Priority Data
Jul. 29, 2024 (DE) 102024121505.4

(51) Int. Cl. B65D 88/74; B65D 90/02; B65D 90/22

(52) U.S. Cl. CPC B65D 88/745; B65D 90/02; B65D 90/22; B65D 2588/12; B65D 2590/0075; B65D 2590/02; B65D 2590/22

(57) ABSTRACT

Disclosed is a method for manufacturing a container for cooling a technical device, in particular a test bench for a technical component, preferably for a compressor, and/or a battery storage device. The method can include a freight container and integrating a cooling device for cooling a cooling liquid into the freight container.

### TECHNICAL FIELD OF THE INVENTION

The invention relates to a freight container with an integrated cooling device for cooling a technical device, in particular a test bench for a technical component, preferably a compressor, and/or a battery storage device, and a corresponding system as well as a method for manufacturing such a container.

### BACKGROUND OF THE INVENTION

Component test benches in which technical devices to be tested, such as compressors, must be cooled are generally known. In addition, battery storage devices often need to be cooled. The solutions proposed in the present context are considered to be comparatively complex.

### SUMMARY OF THE INVENTION

The object of the invention is to propose a concept with which corresponding devices can be cooled in a simple and reliable manner. In particular, a corresponding manufacturing method as well as a corresponding device or system for cooling are to be proposed.

This object is solved by a method.

In particular, the object is solved by a method for manufacturing a container for cooling a technical device, in particular a test bench for a technical component, preferably for a compressor, and/or a battery storage device, wherein the method comprises a provision of a container, in particular a freight container, and an integration of a cooling device for cooling a cooling liquid (for cooling the technical device) into the freight container.

One idea is that an (already existing) container, in particular a freight container, is equipped with a cooling device which is configured to temper a cooling liquid in such a way that technical devices can be cooled with it. By this, in a simple manner, a corresponding cooling, in particular for technical devices, such as compressors, within test benches, and/or an effective cooling of battery storage devices can take place.

The cooling liquid is preferably integrated into the freight container, i.e. is part of the same. The cooling liquid can have a volume or weight of at least 100 ml and/or at least 100 g, preferably at least 1.0 litre and/or at least 1.0 kg, possibly at least 10 litres and/or at least 10 kg.

The cooling liquid can comprise at least 10%, preferably at least 50% and/or at most 99%, preferably at most 90% water and/or an oil and/or an alcohol in terms of weight % and/or volume %. Specifically, the cooling liquid can be a (cooling) brine.

At least one connection device, in particular several connection devices, may be provided in the container in order to guide the cooling liquid past the technical device and/or through it.

The cooling device may have at least one heat pump and/or at least one heat exchanger. At least one pipe for transporting the cooling liquid may be provided in the container.

When providing the freight container, a refrigerated container and/or a freight container, optionally with thermal insulation, may be provided. For example, a (standard) container can be converted. Alternatively or additionally, an existing refrigerated container can be converted, in particular an existing refrigeration system of the refrigerated container can be converted and/or a new refrigeration system can be installed (preferably in order to be able to provide a cooling brine and/or another cooling liquid).

In the case of refrigerated containers with an already installed refrigeration system, the conversion from air to air/brine operation can be carried out in order to use the cooling liquid for cooling the technical equipment. Depending on the performance requirements, the deinstallation and installation of a new system can be can take place or simply a new system can be installed.

The cooling liquid and/or the technical component can be accommodated in the container or be located there.

In a preferred embodiment, a refrigerant, in particular a flammable refrigerant, can be accommodated in the container, in particular in the cooling device of the container.

The container is preferably designed to be explosion-proof (in particular to ensure safe operation). The explosion-proof design is meaningful to minimise risks and hazards that may arise from a potentially flammable refrigerant.

Furthermore, the container can be equipped with at least one (leakage) sensor and/or at least one exhaust air device, in particular, so that it can be shut down as a precaution and/or flushed with fresh air in the event of possible leaks, especially in the case of flammable refrigerants (above a certain concentration).

The freight container may be a used freight container. This offers ecological and economic advantages, as existing resources can be used and costs reduced.

The container may be provided with a double floor, in particular to extract gases and/or fluids and thus ensure additional safety.

The container can be equipped with at least one door and/or at least one window. Such openings facilitate access to the technical devices inside the container and can be used for ventilation.

In a particularly preferred embodiment, the container is an ISO container. The relevant standards (e.g. dimensions, fastenings, stackability) have been coordinatedly decided by the International Maritime Organisation (IMO) and are laid down in ISO standard 668 (validity at the priority or filing date of this application).

Such containers have standardised dimensions, which facilitates handling and transport. For example, the container may have a width of 8 feet and a height of 8 feet 6 inches or 9 feet 6 inches, as well as a length of 10 feet, 20 feet, 40 feet or 45 feet.

The container (or the freight container used in its manufacture) may have: in particular, in the case of a 20-foot standard container, an empty weight of 2200-2600 kg, in particular 2300 kg; or, in particular, in the case of a 40-foot standard container, an empty weight of 3500-4200 kg, in particular 3900 kg; or, in particular in the case of a 45-foot standard container, an empty weight of 4000-5500 kg, in particular 4800 kg; or, in particular in the case of a 10-foot refrigerated container, an empty weight of 2000-2400 kg, in particular 2250 kg, or 2600-3200 kg, in particular 2900 kg; or, in particular in the case of a 20-foot refrigerated container, an empty weight of 2600-3200 kg, in particular 2900 kg; or, in particular in the case of a 40-foot refrigerated container, an empty weight of 4000-5800 kg, in particular 4800 kg; or, in particular in the case of a 45-foot refrigerated container, an empty weight of 4000-6000 kg, in particular 5000 kg.

The solution is preferably trailerable or can be transported on a trailer.

The object is solved in particular by a container, preferably manufactured according to the above method, for cooling a technical device, comprising a cooling device accommodated in the container for cooling a cooling liquid (by means of which a technical device and/or a battery storage device can be cooled). The test room in the container can be regulated to room temperature if necessary in order to meet appropriate requirements. Depending on the final application, an already installed refrigeration system can be used or, alternatively, a recirculation cooler (e.g. split air conditioning unit) can be installed to regulate the temperature of the room, in particular to cool it. Outlets from the refrigeration system can also be provided to operate equipment outside the container if necessary, e.g. to test a vehicle compressor directly on the vehicle.

The object is solved in particular by a vehicle, in particular a truck, and a container mounted on and/or in the vehicle. This configuration allows flexible use of the refrigerated container, as it can be transported on a vehicle and used at different locations.

In particular, the object is also achieved by a method for cooling the technical component, in which a cooling of the technical device is carried out by means of the container (manufactured according to the method described above and/or below or formed according to the following description), whereby the cooling liquid is passed through and/or past the technical device.

Preferably (during cooling and/or testing of the technical device), a temperature in a test room in the container in which the technical device is housed can be brought to room temperature (or to a temperature in ° C. of at least 10, preferably at least 18 and/or at most 30, preferably at most 25), in particular regulated. Depending on the application, an already installed cooling device and/or a circulating air cooler (e.g. split air conditioning unit) can be used.

Outlets from the cooling device can also be provided, e.g. to test or cool for example equipment outside the container if necessary. For example, a person can check a problem on the vehicle, whereby the person wants to test a compressor in the vehicle, for example. To do this, the person could take the equipment out of the container and operate it directly on the vehicle.

A decentralised use of the concept is possible. For example, only electricity may be required for the supply, in which case no additional equipment is necessary.

If a battery is present, in particular if the container is used as a battery storage device, energy for the supply can be drawn from the battery or batteries.

A storage capacity of the battery storage device can be at least 100 kWh, possibly at least 1000 kWh, and/or at most 10 MWh.

The container can be used: In test bench operation for a component test bench, e.g. compressor test bench; and/or for for example flammable refrigerants, in particular if a design (e.g. of a fan) is also explosion-proof; and/or as a (decentralised) battery storage device; and/or for an area without charging infrastructure; and/or as a buffer storage unit at solar and/or wind power plants.

The operation of other equipment which is supplied by the cooling liquid (brine) (e.g. climate chambers) is also possible. In addition, the container can be used as a climate chamber itself.

By the features and measures described an effective and safe cooling of technical devices within a freight container is made possible. The container can preferably be used flexibly and/or easily transported, making it particularly suitable for mobile test benches, decentralised battery storage devices in areas without charging infrastructure, buffer storage at solar and/or wind power plants and other applications where a cooling liquid circuit (brine circuit) is necessary or at least advantageous for temperature control of the technical component(s).

Advantageously, test capacities can be expanded (quickly). Test peaks can be buffered. A laboratory space and/or test bench capacity can be increased.

Furthermore, interconnectivity can be realised, e.g. via at least one DAQ system (data acquisition system) that can be integrated into the container, for example a logger and/or a PC that can send data to a cloud (e.g. via data cable and/or modem).

Further embodiments are apparent from the dependent claims.

The invention is described below, also with regard to further features and advantages, with reference to exemplary embodiments, which are explained in more detail with reference to the figure.

### BRIEF DESCRIPTION OF THE DRAWINGS

FIG. 1 a schematic representation of a container according to the invention.

In the following description, the same reference numbers are used for identical and similarly functioning parts.

FIG. 1 shows, highly schematically, a container manufactured on the basis of a freight container. The container comprises at least one door 10, at least one window 11 and at least one cooling device 12. The cooling device 12 is designed to regulate the temperature of a cooling liquid. This cooling liquid can in turn be used to cool at least one technical device, e.g. a test bench.

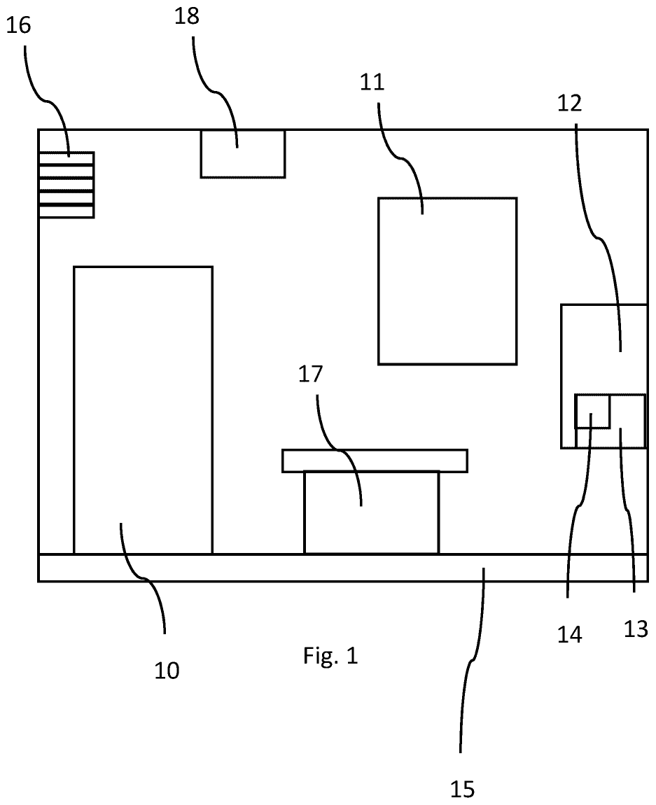

The cooling device preferably comprises at least one heat pump 13 in which a (flammable) refrigerant is used to regulate the temperature of the cooling liquid. At least one heat exchanger 14 may be provided for this purpose.

The container preferably contains a double floor 15 to be able to extract a fluid, in particular gas. A corresponding extraction device may be provided for this purpose.

The container may contain at least one ventilation grille 16.

Furthermore, the container may have at least one sensor system, in particular to be able to detect a leakage of a (flammable) refrigerant.

Furthermore, the container may have at least one (work) table 17 and/or at least one lighting device 18.

At this point, it should be noted that all parts described above each on for itself-even without additional features described in the respective context, even if these have not been explicitly identified as optional features in the respective context, e.g. by using: in particular, preferably, for example, e.g., if applicable, round brackets, etc.—or in combination or any sub-combination are to be regarded as independent embodiments or further developments of the invention, as defined in particular in the introductory description and the claims. Deviations from this are possible. Specifically, it should be noted that the term ‘in particular’ or round brackets do not indicate mandatory features in the respective context.

### DETAILED DESCRIPTION OF THE EMBODIMENTS

10 door
11 window
12 cooling device
13 heat pump
14 heat exchanger
15 floor
16 grille
17 table
18 lighting

1. A method for manufacturing a container for cooling a technical device, comprising:
a. providing a freight container, and
b. integrating a cooling device for cooling a cooling liquid into the freight container.

2. The method according to claim 1, wherein the step of providing the freight container further includes providing a refrigerated container and/or a freight container with a thermal insulation.

3. The method according to claim 1, wherein the cooling liquid and/or the technical device is accommodated in the container.

4. The method according to claim 1, wherein a flammable refrigerant of the cooling device is accommodated in the container.

5. The method according to claim 1, wherein the container is designed to be explosion-proof.

6. The method according to claim 1, wherein the freight container is a used freight container.

7. The method according to claim 1, wherein the container is or will be provided with a double floor.

8. The method according to claim 1, wherein the container is or will be provided with at least one door and/or at least one window.

9. The method according to claim 1, further comprising integrating an interconnectivity via at least one DAQ system (data acquisition system).

10. The method according to claim 1, wherein the container is an ISO container and/or has:
a width of 8 feet and/or
a height of 8 feet 6 inches or 9 feet 6 inches and/or
a length of 10 feet, 20 feet, 40 feet or 45 feet.

11. The method according to claim 1, wherein the freight container is an ISO container; and/or has:
a width of 8 feet and/or
a height of 8 feet 6 inches or 9 feet 6 inches and/or
a length of 10 feet, 20 feet, 40 feet or 45 feet and/or
i) in the case of a 20-foot standard container, an empty weight of 2200-2600 kg, or
ii) in the case of a 40-foot standard container, an empty weight of 3500-4200 kg, or
iii) in the case of a 45-foot standard container, an empty weight of 4000-5500 kg;
iv) in the case of a 10-foot refrigerated container, an empty weight of 2600-3200 kg, or
v) in the case of a 20-foot refrigerated container, an empty weight of 2600-3200 kg, or
vi) in the case of a 40-foot refrigerated container, an empty weight of 4000-5800 kg, or
vi) in the case of a 45-foot refrigerated container, an empty weight of 4000-6000 kg.

12. A container manufactured according to claim 1, for cooling a technical device, comprising a cooling device accommodated in the container for cooling a cooling liquid.

13. A system comprising a vehicle and a container according to claim 12 accommodated on and/or in the vehicle.

14. A method for cooling a technical device, in which a cooling of the technical device is carried out by means of a container manufactured according to claim 1, wherein the cooling liquid is passed through and/or past the technical device.
